(19) United States
(12) Patent Application Publication
(10) Pub. No.: US 2003/0020998 A1
(43) Pub. Date: Jan. 30, 2003

(54) Optical subassembly (OSA) for optoelectronic modules, and method of making same

(75) Inventor: Joseph Paul Kuczynski, Rochester, MN (US)

Correspondence Address: Steven W. Roth, IBM Corporation, Dept. 917, 3605 Highway 52 North, Rochester, MN, 55901-7829, US

(73) Assignee: INTERNATIONAL BUSINESS MACHINES CORPORATION, ARMONK, NY (US)

(21) Appl. No.: 09/915,884

(22) Filed: Jul. 26, 2001

(51) Int. Cl. G02F 1/07; G02F 1/03

(52) U.S. Cl. 359/245

(57) ABSTRACT

An optical subassembly for an optoelectronic module includes an adhesive interface between a lens and an optoelectronic device, e.g., having a laser or a photoelectric receiver chip. In addition to eliminating moisture condensation, the adhesive interface can eliminate damage to a structural adhesive that may occur when air of a conventional interface expands as the structural adhesive is cured. The adhesive interface has optical transmittance at the optoelectronic device's operating wavelength, e.g., 850 nm. The lens surface shape is selected based on the adhesive interface's refractive index. An adhesive is applied both to the lens and to the optoelectronic device, which are then joined and the adhesive cured to form the adhesive interface. The adhesive is cured by exposure to UV radiation and/or heat, for example.

### FIELD OF THE INVENTION

The present invention relates in general to optoelectronic modules. More particularly, the present invention relates to an optical subassembly (OSA) for optoelectronic transceiver modules, and a method of making the same.

### BACKGROUND

The development of the EDVAC computer system of 1948 is often cited as the beginning of the computer era. Since that time, computer systems have evolved into extremely sophisticated devices, and computer systems may be found in many different environments. Since the dawn of the computer age, cables have been used to transfer data between computers and input/output devices, and between computers. For example, cables are used in input/output (I/O) device attachment applications, such as disk drive, tape storage and printer attachment. Cables are also used in networking applications, such as local-area networks (LANs) and widearea networks (WANs). An important trend in the past ten years has been the increasing use of fiber optic cables in such applications.

Fiber optic cables typically include a connector at each end that is plugged into a receptacle associated with the computer or I/O device. Typically the receptacle is part of an optoelectronic module that is electrically connected to the computer or I/O device. For example, the optoelectronic module may be connected to an electronic circuit board of the computer or I/O device using a fixed connection, e.g., a pin-through-hole arrangement, or a removable connection, e.g., a hot-pluggable contact pad mechanism. The optoelectronic module may receive optical signals from a fiber optic cable plugged into its receptacle and/or may transmit optical signals to a fiber optic cable plugged into the receptacle. An optoelectronic module that both transmits and receives optical signals is often referred to as an optoelectronic transceiver module.

An optoelectronic transceiver module typically receives optical signals from the fiber optic cable, converts the optical signals to electrical signals, and provides the electrical signals to the electronic circuit board of the computer or I/O device. Likewise, an optoelectronic transceiver module typically receives electrical signals from the electronic circuit board of the computer or I/O device, converts the electrical signals to optical signals, and provides the optical signals to the fiber optic cable. The optoelectronic transceiver module typically receives optical signals from the fiber optic cable using a receiver optical subassembly (ROSA) and provides the optical signals to the fiber optic cable using a transmitter optical subassembly (TOSA).

A ROSA typically includes a lens that receives the optical signals from the fiber optic cable and focusses the optical signals on an optoelectronic device provided with a receiver unit, e.g., a photoelectric receiver chip, that converts the fiber optic signals to electrical signals. Similarly, a TOSA typically includes an optoelectronic device provided with a transmitter unit, e.g., an edge-emitting laser (CD) or a surface-emitting laser (VCSEL), that converts electrical signals to optical signals that are directed onto a lens that directs the optical signals to the fiber optic cable.

Typically, an optoelectronic device is in the form of a transistor-outline (TO) can, both for TOSAs and ROSAs. TO-cans are advantageous in that they offer a hermetic, high-reliability package. OSAs, i.e., TOSAs or ROSAs, typically have a housing member that is used to house the lens and the optoelectronic device and to align the lens with respect to the transmitter unit or receiver unit of the optoelectronic device. The housing member may, for example, be injection molded using an optically clear plastic so that the lens may be integrally formed with the housing member. Typically, the optoelectronic device TO-can is placed within the housing member and aligned (e.g., in the X, Y and Z axes) with respect to the lens using an alignment tool. The TO-can is tacked in place by then applying a UV curable adhesive bead in an area between a deck portion of the TO-can and a lip portion of the housing member, the OSA is then removed from alignment tool, and then a structural adhesive is dispensed over the tacking adhesive and cured to provide rigidity and durability to the OSA. During the structural adhesive curing process, heat can cause the air in the cavity within the OSA between the interior of the housing member and the TO-can to expand and escape by blowing a vent hole through the structural adhesive. This can result in a non-hermetic OSA package that may require subsequent touch up. In addition to producing the vent hole problem, the air interface between the optoelectronic device and the lens can produce a fogging problem, i.e., moisture condensation on the transmitter or receiver units and/or the lens of the optoelectronic device.

Therefore, there exists a need to provide an enhanced optical subassembly (OSA), and a method of making the same.

### SUMMARY OF THE INVENTION

An object of the present invention is to provide an enhanced optical subassembly (OSA), and method of making the same, that addresses these and other problems associated with the prior art.

These and other objects of the present invention are achieved by providing an enhanced optical subassembly, and a method of making the same, that includes an adhesive interface between a lens and an optoelectronic device, e.g., having a laser or a photoelectric receiver chip. In addition to eliminating moisture condensation, the adhesive interface can eliminate damage to a structural adhesive that may occur when air of a conventional interface expands as the structural adhesive is cured. The adhesive interface has optical transmittance at the optoelectronic device's operating wavelength, e.g., 850 nm. The lens surface shape is selected based on the adhesive interface's refractive index. An adhesive is applied both to the lens and to the optoelectronic device, which are then joined and the adhesive cured to form the adhesive interface. The adhesive is cured by exposure to UV radiation and/or heat, for example.

### BRIEF DESCRIPTION OF THE DRAWINGS

The present invention together with the above and other objects and advantages can best be understood from the following detailed description of the embodiments of the invention illustrated in the drawings, wherein like reference numerals denote like elements.

FIG. 1 is a block diagram of a networked computer system consistent with the present invention.

FIG. 2 is an exploded perspective view of an optoelectronic transceiver module having a pair of optical subassemblies (OSAs) consistent with the present invention.

FIG. 3 is an exploded perspective enlarged view of one of the optical subassemblies (OSAS) of the optoelectronic transceiver module shown in FIG. 2. The OSA is shown in FIG. 3 prior to application of the adhesive interface.

FIG. 4 is a cross-sectional view of an optical subassembly (OSA) that includes an adhesive interface according to an embodiment of the present invention.

### DETAILED DESCRIPTION OF THE PREFERRED EMBODIMENTS

### Hardware Environment

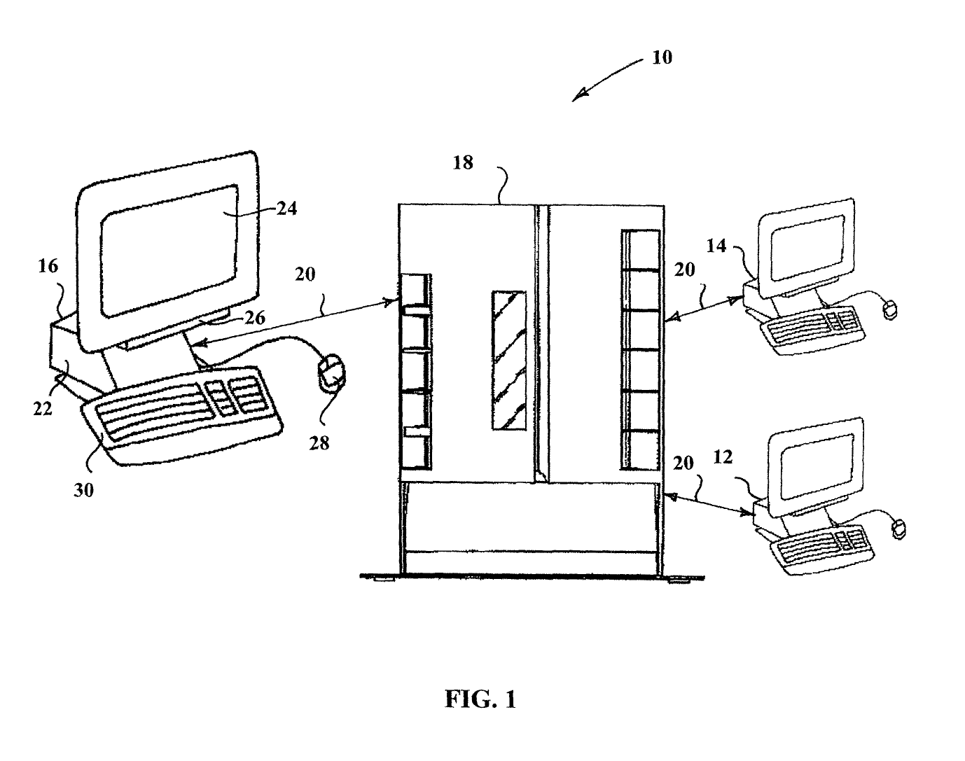

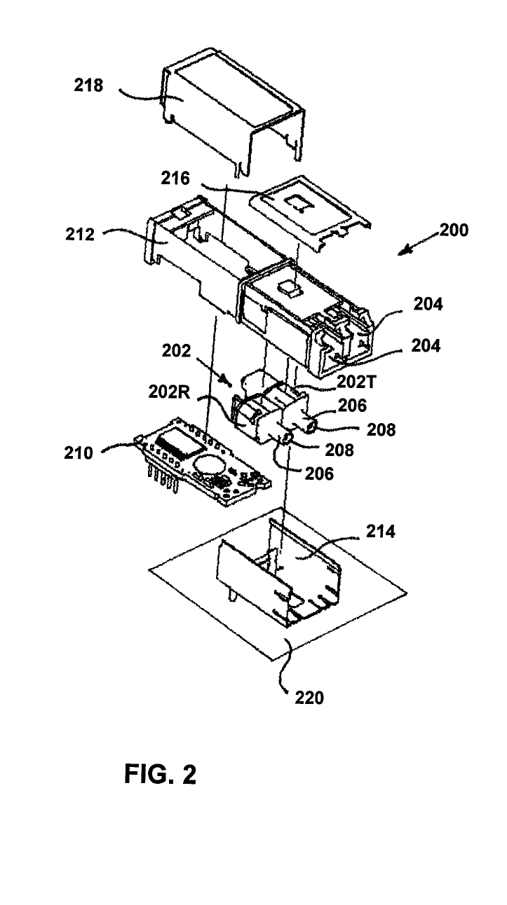

FIG. 1 illustrates a computer system 10 that is consistent with the invention. Computer system 10 is illustrated as a networked computer system. Computer system 10 includes one or more client computers 12, 14 and 16 (e.g., desktop or PC-based computers, workstations, etc.) coupled to server computer 18 (e.g., a PC-based server, a minicomputer, a midrange computer, a mainrame computer, etc.) through a network 20. The server computer 18 may comprise a plurality of enclosures as an alternative to the single enclosure illustrated in FIG. 1. Network 20 may represent practically any type of networked interconnection. For example, network 20 may be a local-area network (LAN), a wide-area network (WAN), a wireless network, and a public network (e.g., the Internet). Moreover, any number of computers and other devices may be networked through the network 20, e.g., multiple servers. In one application of the present invention, server computer 18 and one or more of client computers 12, 14 and 16 may each include an optoelectronic module (shown in FIG. 2) having an optical subassembly provided with an adhesive interface according to the present invention and a receptacle into which may be plugged an optic fiber cable to form network 20 or a portion thereof. For example, the optoelectronic module may be connected to an electronic circuit board of a networking adapter of the computer using a conventional fixed connection, e.g., a pin-through-hole arrangement, or a conventional removable connection, e.g., a hot-pluggable contact pad mechanism.

Client computer 16, which may be similar to client computers 12 and 14, may include a central processing unit (CPU) 22; a number of peripheral components such as a computer display 24; a storage device 26; and various input devices (e.g., a mouse 28 and a keyboard 30), among others. Server computer 18 may be similarly configured, albeit typically with greater processing performance and storage capacity, as is well known in the art. In another application of the present invention, input/output devices (e.g., disk drives, tape drives and printers) and client computer 16 (or server computer 18) may each include an optoelectronic module (shown in FIG. 2) having an optical subassembly provided with an adhesive interface according to the present invention and a receptacle into which may be plugged an optic fiber cable that forms an interconnection (or a portion thereof) between the input/output devices and client computer 16 (or server computer 18). For example, the optoelectronic module may be connected to an electronic circuit board of an I/O adapter of the computer using a conventional fixed connection, e.g., a pin-through-hole arrangement, or a conventional removable connection, e.g., a hot-pluggable contact pad mechanism.

In yet another application of the present invention, various other electronic components of client computer 16 (or server computer 18) may each include an optoelectronic module (shown in FIG. 2) having an optical subassembly provided with an adhesive interface according to the present invention and a receptacle into which may be plugged an optic fiber cable that forms an interconnection (or a portion thereof) between the electronic components within a single computer enclosure and/or between a plurality of enclosures of the computer. For example, the optoelectronic module may be connected to an electronic circuit board of each of such electronic components of the computer using a conventional fixed connection, e.g., a pin-through-hole arrangement, or a conventional removable connection, e.g., a hot-pluggable contact pad mechanism.

Although shown and described above in the environment of a computer, the present invention is not limited thereto. In general, the optical subassembly of the present invention may be used in any electrical devices or components that utilize a fiber optic cable interconnection.

FIG. 2 is an exploded perspective view of an optoelectronic transceiver module 200 having a pair of optical subassemblies (OSAs) 202 consistent with the present invention. The pair of OSAs includes a receiver optical subassembly (ROSA) 202R and a transmitter optical subassembly (TOSA) 202T. It should be appreciated, however, that the present invention is not limited to the use of a pair of OSAs. Any number of OSAs may be used. Moreover, the present invention is not limited to use in the context of an optical transceiver module. For example, the present invention may be employed with respect to an optoelectronic receiver module or a optoelectronic transmitter module.

Optoelectronic transceiver module 200 includes a pair of receptacles 204, each of which is associated with one of OSAs 202 and into which may be plugged a connector (not shown) of a fiber optic cable (not shown). The OSAs 202 and receptacles 204 shown in FIG. 2 are based on the LC optical connector. The OSAs 202 each include a projection 206 that extends into one receptacle 204 and has an optical fiber bore 208 for receiving a ferrule of a fiber optic cable connector that is to be mated therewith. Although OSAs 202 and receptacles 204 shown in FIG. 2 are based on the LC optical connector, the OSAs and receptacles may be based on other types of connectors, such as the MTP optical connector (also known as the type MPO connector), the SC optical connector, or the like.

The OSAs 202 are electrically connected to an electronic circuit board 210 that incorporates circuitry of the type conventionally included in optoelectronic transceiver modules, such as a laser driver, laser control, receiver post-amplifier, signal-detect circuits, and power-on reset circuits. Typically, receptacles 204 are integrally formed as a portion of a plastic retainer 212 that retains OSAs 202 and electronic circuit board 210 in position. Alternatively, receptacles 204 and a retainer member may be formed separately as two or more pieces. A bottom cover 214, a top front cover 216, and a top rear cover 218 form the housing of optoelectronic transceiver module 200. Typically, these cover members are made of metal to provide electromagnetic shielding.

Typically, optoelectronic transceiver module 200 is electrically connected to an electronic circuit board 220 of a computer or I/O device. For example, optoelectronic transceiver module 200 may be connected to electronic circuit board 220 of the computer or I/O device using a fixed connection as shown in FIG. 2, e.g., a pin-through-hole arrangement that connects electronic circuit board 210 of optoelectronic transceiver module 200 to electronic circuit board 220 of the computer or I/O device. Alternatively, optoelectronic transceiver module 200 may be connected to electronic circuit board 220 of the computer or I/O device using a removable connection, e.g., a hot-pluggable contact pad mechanism that connects electronic circuit board 210 of optoelectronic transceiver module 200 to electronic circuit board 220 of the computer or I/O device.

Optoelectronic transceiver module 200 receives optical signals from the fiber optic cable, converts the optical signals to electrical signals, and provides the electrical signals to the electronic circuit board 220 of the computer or I/O device. Likewise, optoelectronic transceiver module 200 receives electrical signals from the electronic circuit board 220 of the computer or I/O device, converts the electrical signals to optical signals, and provides the optical signals to the fiber optic cable. Optoelectronic transceiver module 200 receives optical signals from the fiber optic cable using receiver optical subassembly (ROSA) 202R and provides the optical signals to the fiber optic cable using transmitter optical subassembly (TOSA) 202T.

A ROSA typically includes a lens that receives the optical signals from the fiber optic cable and focusses the optical signals on an optoelectronic device provided with a receiver unit, e.g., a photoelectric receiver chip, that converts the fiber optic signals to electrical signals. Similarly, a TOSA typically includes an optoelectronic device provided with a transmitter unit, e.g., an edge-emitting laser (CD) or a surface-emitting laser (VCSEL), that converts electrical signals to optical signals that are directed onto a lens that directs the optical signals to the fiber optic cable.

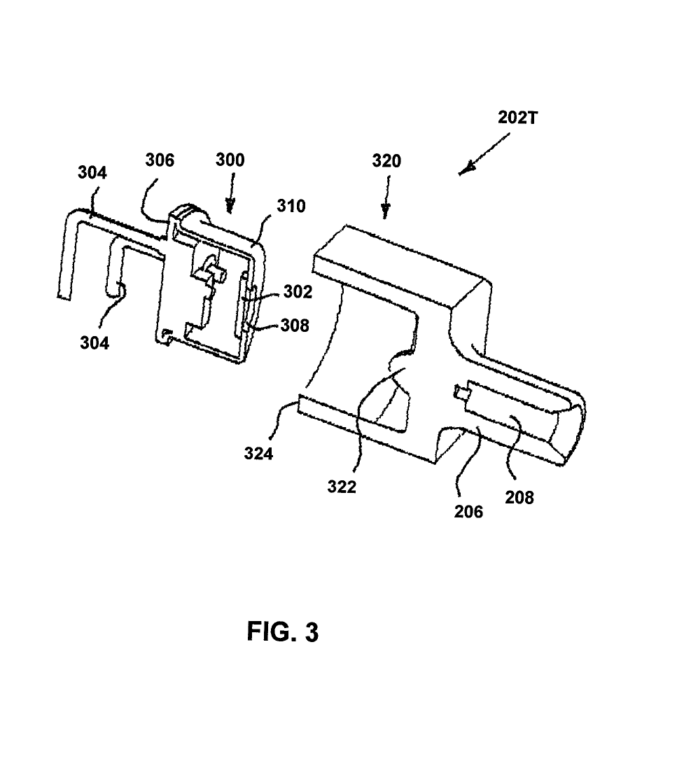

FIG. 3 is an exploded perspective enlarged view of one of the optical subassemblies (OSAs) 202 of the optoelectronic transceiver module shown in FIG. 2. The OSA is shown in FIG. 3 prior to application of the adhesive interface of the present invention. Although only transmitter optical subassembly (TOSA) 202T is shown in FIG. 3, the present invention may also be employed in receiver optical subassembly (ROSA) 202R, which has a similar structure.

TOSA 202T includes an optoelectronic device 300 provided with a transmitter unit 302, e.g., an edge-emitting laser (CD) or a surface-emitting laser (VCSEL), that converts electrical signals to optical signals that are directed onto a lens 322 that directs the optical signals to the fiber optic cable. Although not shown, ROSA 202R includes a similar optoelectronic device with a receiver unit, e.g., a photoelectric receiver chip, that converts the fiber optic signals to electrical signals. Typically, optoelectronic device 300 is in the form of a transistor-outline (TO) can as shown in FIG. 3, both for TOSAs and ROSAs. TO-cans are advantageous in that they offer a hermetic, high-reliability package. The electrical signals are provided to TOSA 202T through electrodes 304 that exit a deck portion 306 at the rear of the TO-can. The optical signals exit TOSA 202T through a window 308 in a cup-shaped portion 310 at the front of the TO-can.

TOSA 202T (ROSA 202R) has a housing member 320 that is used to enclose optoelectronic device 300 and a lens 322 and to align lens 322 with respect to the transmitter unit (receiver unit) of optoelectronic device 300. Housing member 320 is preferably injection molded using an optically clear plastic, e.g., Ultem® polyetherimide available from GE Plastics, so that lens 322 and projection 206 may be integrally formed with housing member 320. As discussed above, projection 206 is provided with an optical fiber bore 208 for receiving a ferrule of a fiber optic cable connector that is to be mated therewith. Alternatively, housing member 320, lens 322 and projection 206 may be formed separately as two or more pieces.

Conventionally, optoelectronic device 300 is placed within housing member 320 and aligned (e.g., in the X, Y and Z axes) with respect to lens 322 using an alignment tool. Next, optoelectronic device 300 is tacked in place by applying a UV curable adhesive bead in an area between deck portion 306 of the TO-can and a lip portion 324 of housing member 320. Then, OSA 202 is removed from alignment tool. Finally, a structural adhesive is dispensed over the tacking adhesive and cured to provide rigidity and durability to OSA 202. During the structural adhesive curing process, heat can cause the air in the cavity within the OSA between the interior of housing member 320 and optoelectronic device 300 to expand and escape by blowing a vent hole through the structural adhesive. This can result in a non-hermetic OSA package that may require subsequent touch up. In addition to producing the vent hole problem, the conventional air interface between optoelectronic device and the lens can produce a fogging problem, i.e., moisture condensation on the transmitter or receiver units and/or the lens of the optoelectronic device.

The present invention addresses these and other problems by utilizing an adhesive interface between lens 322 and optoelectronic device 300.

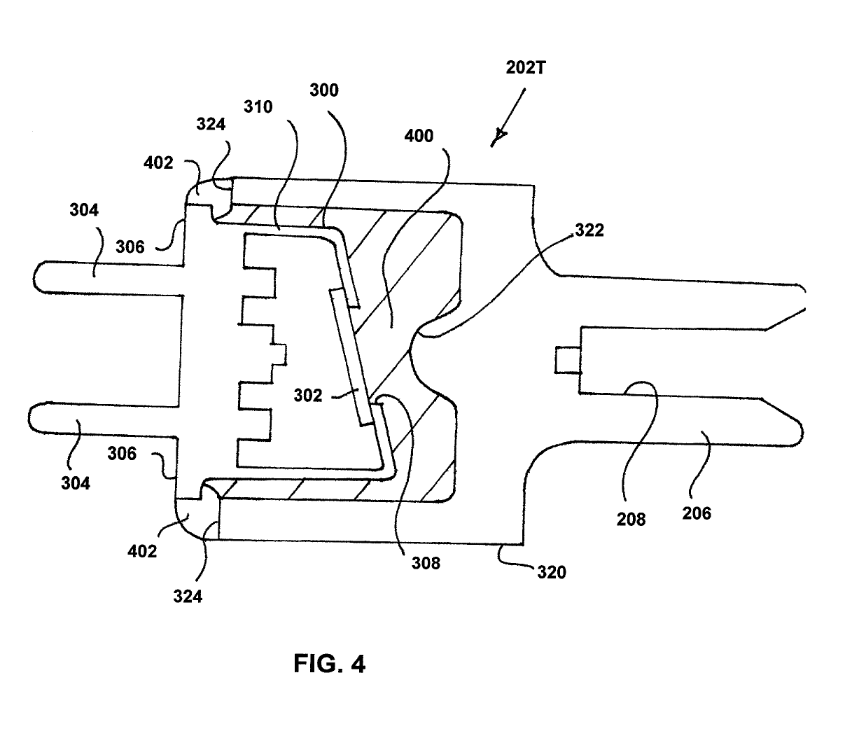

Optoelectronic Subassembly with Adhesive Interface FIG. 4 is a cross-sectional view of an optical subassembly (OSA) that includes an adhesive interface 400 according to an embodiment of the present invention. Although a transmitter optical subassembly (TOSA) is shown in FIG. 4 for the purpose of illustration, the present invention is also applicable in a receiver optical subassembly (ROSA).

Adhesive interface 400 is included between lens 322 and optoelectronic device 300, e.g., having a laser 302 or a photoelectric receiver chip. In addition to eliminating moisture condensation, the adhesive interface can eliminate damage to a structural adhesive 402 that may occur when air of a conventional interface expands as the structural adhesive 402 is cured. Adhesive interface 400 preferably contacts substantially the entire interior surface of housing member 320 and substantially the entire exterior surface of the cup-shaped portion 310 of optoelectronic device 300. This not only fills the air gap and eliminates the conventional air interface, but also increases the surface area available for bonding.

The surface shape of lens 322 is selected based on the refractive index of adhesive interface 400. Because the index of refraction of adhesive interface 400 is likely greater than that of air, the surface shape of lens 322 may need to be made more aspherical (elliptical) as compared to a conventional air interface.

Adhesive interface 400 is formed by curing an adhesive material. Preferably, the adhesive material is optically clear at the operating wavelength of the optoelectronic device, curable via UV and/or thermal initiation, rapid curing, has excellent adhesion to high surface energy plastics and metals, and has adequate viscosity. With regard to the adhesive material preferably being optically clear at the operating wavelength (e.g., 850 nm) of the optoelectronic device, a transmittance of at least 90% is preferred for an unattenuated OSA. However, transmittance can be tailored via incorporation of an appropriate conventional dye such that the laser power is reduced to acceptable levels. Highly filled adhesive materials will be opaque at the operating wavelength of the optoelectronic device.

With regard to the adhesive material preferably being curable via UV and/or thermal initiation, the adhesive material may have a sluggish cure speed due to absorption of UV radiation by the housing member. In this case, a conventional thermal initiator may be added to the adhesive material to drive the conversion toward completion. With regard to the adhesive material preferably being rapid curing, the OSAs are typically individually aligned (i.e., the laser (or receiver chip) of optoelectronic device is aligned with respect to the lens) and thus throughput is gated by the alignment/cure process. Rapid curing ensures that cycle time will be kept to a minimum.

With regard to the adhesive material preferably having excellent adhesion to high surface energy plastics and metals, the adhesive material will preferably function to better adhere the optoelectronic device to the housing member (as well as being an index-matching material). Thus, the adhesive material will preferably exhibit excellent adhesion to surfaces of the housing member (e.g., Ultem) and surfaces of the optoelectronic device (e.g., gold and/or nickel).

With respect to the adhesive material preferably having adequate viscosity, the adhesive material is preferably dispensed on both the laser (or receiver chip) and the lens surfaces prior to mating the optoelectronic device to the housing member in order to prevent air entrapment at either the laser or the lens surfaces. The viscosity must be high enough to prevent excessive slumping or dripping yet low enough to enable adequate wetting of both surfaces. A suitable range is between 500-100,000 cP.

Suitable adhesive materials include, for example, acrylic adhesives, urethane-acrylate adhesives, epoxy adhesives, silicone-based adhesives and mixtures thereof. Such acrylic adhesives include, for example, multifunctional acrylated blends, organic peroxide (thermal initiator), and aromatic ketone photoinitiator. Such urethane-acrylate adhesives include, for example, polyurethane oligomer, acrylic acid, t-butyl perbenzoate (thermal initiator), photoinitiator (benzoin derivatives, etc.), and methacrylate polymer. Such epoxy adhesives include, for example, bisphenol A-based resin, cycloaliphatic epoxy resin, polyol, and aryl antimonate (sulfonium and/or iodonium antimonate). Such silicone-based adhesives are commercially-available from Wacker Silicones, GE Silicones, and others. Illustrative suitable commercially-available adhesive materials include, for example, Optocast epoxy-based adhesives (available from Electronic Materials Inc.), 6-628 and 9001 polyurethane oligomer-based adhesives (available from Dymax Corporation), and Eccobond UV 9030 polyurethane oligomer-based adhesive (available from Emerson and Cumings).

The adhesive material is applied both to lens 322 (preferably, to substantially the entire interior surface of housing member 320) and window 308 of optoelectronic device 310 (preferably, to substantially the entire exterior surface of the cup-shaped portion 310 of optoelectronic device 300). Next, housing member 320 and optoelectronic device 300 are joined and aligned. Finally, the adhesive material is cured to form adhesive interface 400. The adhesive material may be cured by exposure to UV radiation and/or heat, for example. In addition, a conventional structural adhesive 402 may be dispensed in an area between deck portion 306 of the TO-can and a lip portion 324 of housing member 320 and cured to provide additional rigidity and durability to OSA 202.

The present invention has several advantages over the conventional air interface. For example, the present invention makes it possible to: eliminate the precision placement of the tacking adhesive; improve adhesion due to the greater surface area available for bonding; eliminate venting of trapped air as the structural adhesive is cured (and thereby improve the cycle time since no touch up or other secondary operation is required); eliminate moisture condensation on the lens and/or laser (or receiver chip) window; and tailor the transmittance of the adhesive interface via incorporation of an appropriate dye.

While this invention has been described with respect to the preferred and alternative embodiments, it will be understood by those skilled in the art that various changes in detail may be made therein without departing from the spirit, scope, and teaching of the invention. Accordingly, the herein disclosed invention is to be limited only as specified in the following claims.

What is claimed is:

1. An optical subassembly for an optoelectronic module, comprising:
a lens;
an optoelectronic device;
an adhesive interface positioned between and in physical contact with the lens and the optoelectronic device.

2. The optical subassembly as recited in claim 1, wherein optoelectronic device includes a laser.

3. The optical subassembly as recited in claim 1, wherein optoelectronic device includes a photoelectric receiver chip.

4. The optical subassembly as recited in claim 1, wherein the lens has a surface the shape of which is selected based on a refractive index of the adhesive interface.

5. The optical subassembly as recited in claim 1, wherein the lens is integrally formed with a housing member of the optical subassembly, and wherein the adhesive interface is in physical contact with at least a portion of the housing member that does not comprise the lens.

6. The optical subassembly as recited in claim 5, wherein at least a portion of the housing member and the lens is formed from polyetherimide.

7. The optical subassembly as recited in claim 1, wherein the adhesive interface has a predetermined optical transmittance at the operating wavelength of the optoelectronic device.

8. The optical subassembly as recited in claim 7, wherein the operating wavelength of the optoelectronic device is about 850 nm.

9. The optical subassembly as recited in claim 1, wherein the adhesive interface is formed by curing an adhesive material selected from the group consisting of acrylic adhesives, urethane-acrylate adhesives, epoxy adhesives, and mixtures thereof.

10. The optical subassembly as recited in claim 9, wherein the adhesive material is a urethane-acrylate adhesive that includes a polyurethane oligomer.

11. An optoelectronic module, comprising:
a housing;
an electronic circuit board mounted within the housing;
at least one optical subassembly connected to the electronic circuit board, the at least one optical subassembly comprising:
a lens;
an optoelectronic device;
an adhesive interface positioned between and in physical contact with the lens and the optoelectronic device.

12. The optoelectronic module as recited in claim 11, wherein the at least one optical subassembly includes a transmitter optical subassembly the optoelectronic device of which includes a laser, and wherein the at least one optical subassembly includes a receiver optical subassembly the optoelectronic device of which includes a photoelectric receiver chip.

13. The optoelectronic module as recited in claim 11, wherein the lens has a surface the shape of which is selected based on a refractive index of the adhesive interface.

14. The optoelectronic module as recited in claim 11, wherein the lens is integrally formed with a housing member of the optical subassembly, and wherein the adhesive interface is in physical contact with at least a portion of the housing member that does not comprise the lens.

15. A method of making an optical subassembly for an optoelectronic module, comprising the steps of:
applying an adhesive to a lens;
applying an adhesive to an optoelectronic device;
joining the lens having the adhesive applied thereto and the optoelectronic device having the adhesive applied thereto;
curing the joined adhesive to form an adhesive interface positioned between and in physical contact with the lens and the optoelectronic device.

16. The method as recited in claim 15, wherein optoelectronic device includes a laser.

17. The method as recited in claim 15, wherein optoelectronic device includes a photoelectric receiver chip.

18. The method as recited in claim 15, wherein the lens is integrally formed with a housing member of the optical subassembly, and wherein the step of applying the adhesive to the lens further comprises applying the adhesive to a portion of the housing member that does not comprise the lens, whereby the adhesive interface is formed in physical contact with at least the portion of the housing member that does not comprise the lens.

19. The method as recited in claim 15, wherein the adhesive includes an adhesive material selected from the group consisting of acrylic adhesives, urethane-acrylate adhesives, epoxy adhesives, silicone-based adhesives, and mixtures thereof.

20. The method as recited in claim 18, wherein the curing step includes the step of exposing the joined adhesive to UV radiation through the housing member.

21. The method as recited in claim 15, wherein the curing step includes the step of heating the joined adhesive.
